(19) United States
(12) Patent Application Publication
(10) Pub. No.: US 2014/0225501 A1
(43) Pub. Date: Aug. 14, 2014

(54) ADJUSTED PULSE WIDTH MODULATED DUTY CYCLE OF AN INDEPENDENT FILAMENT DRIVE FOR A GAS DISCHARGE LAMP BALLAST

(71) Applicant: LUTRON ELECTRONICS CO., INC., Coopersburg, PA (US)

(72) Inventor: Brent M. Gawrys, Whitehall, PA (US)

(73) Assignee: Lutron Electronics Co., Inc., Coopersburg, PA (US)

(21) Appl. No.: 13/763,481

(22) Filed: Feb. 8, 2013

(51) Int. Cl. H01J 61/52; H05B 41/24

(52) U.S. Cl. CPC H01J 61/526; H05B 41/24
USPC 315/106

(57) ABSTRACT

An electronic dimming ballast for driving a gas discharge lamp may be operable to control the duty cycle of an independent filament drive (IFD) to avoid hard switching and operation of the switches of the IFD outside their safe operating area. Such a ballast may include a first inverter for generating a first high-frequency alternating current (AC) voltage for powering the gas discharge lamp, and a second inverter for generating a second high-frequency AC voltage for heating the filament, wherein the second inverter is driven independent of the first inverter. The second inverter may be configured to adjust a duty cycle of the second high-frequency AC voltage from a starting duty cycle to a target duty cycle at a rate. The rate may be controlled to be below a threshold. The ballast may include a controller for maintaining the rate below the threshold.

### BACKGROUND

A fluorescent lamp may include a sealed glass tube retaining a rare earth gas, and an electrode at each end for striking and maintaining an electric arc through the gas. The electrodes may be constructed as filaments to which a filament voltage may be applied to heat the electrodes, thereby improving their capability to emit electrons. For example, heating the filaments may result in improved electric arc stability and longer lamp life.

Ballasts may apply the filament voltage to the filaments prior to striking the arc (e.g., during preheat) and maintain the filament voltages throughout the entire dimming range of the lamp. Near low end, when light levels are lowest and, consequently, the electric arc is at its lowest level, the filament voltage may help maintain a stable arc current. Near high end, when light levels are highest, and the electric arc current is at its highest level, the electric arc current may contribute to heating the filaments.

FIG. 1 is a perspective view of an example gas discharge lamp fixture 100. The fixture 100 includes a ballast 102, lamp sockets 104, and a housing 106. The ballast 102 and the sockets 104 may be fixed to the housing 106. The lamp sockets 104 may be sized and situated within the housing 106 to hold lamps 108. The ballast 102 may have wires 110 to connect the ballast 102 to the sockets 104 for driving the lamps 108 and for providing heating current, as discussed above.

An electronic dimming ballast may include a front end circuit, which produces a direct-current (DC) bus voltage, and a back end circuit, which converts the DC bus voltage into a high-frequency alternating-current (AC) voltage for driving the lamps. The back end circuit may include a first power converter (e.g., a first inverter circuit) for generating the high-frequency AC voltage, and an output circuit having a resonant tank for coupling the high-frequency AC voltage to the lamps. The output circuit may also comprise a first DC-blocking capacitor for preventing DC current from flowing through the lamps.

The back end circuit may also comprise a second power converter (e.g., a second inverter circuit) for providing AC voltages to the filaments of the lamps via a transformer. The second inverter circuit may generate an AC voltage across a primary winding of the transformer. The transformer comprises a plurality of secondary windings that provide the AC voltages to the filaments of the lamp. If a DC voltage is generated across the primary winding of the transformer, the core of the transformer may saturate, which may cause losses within the electronic dimming ballast and the second inverter circuit, degradation of the switches (e.g., FETs) of the second inverter circuit, hard switching of the switches of the second inverter, etc. Therefore, there is a need for systems and methods that may allow for heating of the filaments using an inverter circuit and a transformer, while avoiding the aforementioned issues that may result from the saturation of the core of the transformer.

### SUMMARY

An electronic dimming ballast for driving a gas discharge lamp may be operable to control the duty cycle of an independent filament drive (IFD) to avoid hard switching and operation of the switches of the IFD outside their safe operating area. Such a ballast may include a first inverter for generating a first high-frequency alternating current (AC) voltage for powering the gas discharge lamp, and a second inverter for generating a second high-frequency AC voltage for heating the filament, wherein the second inverter is driven independent of the first inverter. The second inverter may be configured to adjust a duty cycle of the second high-frequency AC voltage from a starting duty cycle to a target duty cycle at a rate. The rate may be controlled to be below a threshold. The ballast may include a controller for maintaining the rate below the threshold.

Upon reaching the target duty cycle, the first inverter may strike the lamp. For example, upon reaching the target duty cycle, the first inverter may be configured to power the lamp with the first high-frequency AC voltage. The second inverter may comprise a transformer having a primary winding for receiving the second high-frequency AC voltage and a secondary winding adapted to be coupled to the filament of the lamp for heating the filament. The second inverter may be configured to adjust the duty cycle of the second high-frequency AC voltage such that saturation of the transformer of the second inverter is avoided. The second inverter may be configured to be adjusted such that switches of the second inverter stay within a safe operating area. For example, the second inverter may be adjusted every two inverter cycles.

The rate may be calculated as duty cycle percent change per unit time. The rate may be calculated as duty cycle percent change per inverter cycle. The rate may be 0.01% duty cycle per two inverter cycles. The starting duty cycle may be 0%, the target duty cycle may be 45%, and the second inverter may be configured to be adjusted from the starting duty cycle to the target duty cycle in 100 ms.

The second inverter may be configured to be periodically increase the duty cycle of the second high-frequency AC voltage from the starting duty cycle to the target duty cycle at the rate. An operating frequency of the first high-frequency AC voltage generated by the first inverter may be driven independently of an operating frequency of the second high-frequency AC voltage generated by the second inverter. The first inverter may comprise a half-bridge inverter that may have two semiconductor switches that may be configured to be driven using a symmetric duty cycle switching mode of operation to generate the first high-frequency AC voltage. The second inverter may comprise a half-bridge inverter that may have two semiconductor switches that may be configured to be driven using a symmetric duty cycle switching mode of operation to generate the second high-frequency AC voltage.

The ballast may include a filament winding magnetically coupled to an inductor and operable to supply the second high-frequency AC voltage to the filament. The ballast may include a control circuit configured to control generation of the first and second high frequency AC filament voltages.

A method for driving a gas discharge lamp with a ballast operable to control the duty cycle of an independent filament drive (IFD) to avoid hard switching and operation of the switches of the IFD outside their safe operating area may be provided. The method may include driving a first inverter to generate a first high-frequency alternating current (AC) voltage for powering the gas discharge lamp, and driving a second inverter to generate a second high-frequency AC voltage for heating the filament. The second inverter may be driven independent of the first inverter. The second inverter may be adjusted from a starting duty cycle to a target duty cycle at a rate. The rate may be controlled to be below a threshold.

### BRIEF DESCRIPTION OF THE DRAWINGS

FIG. 1 is a perspective view of an example gas discharge lamp fixture.

FIG. 2 is a simplified block diagram of an example of a dimming ballast for driving multiple lamps.

FIG. 3 shows a simplified schematic diagram of an example back end.

FIG. 4A is graph illustrating an example of an IFD inverter voltage V_{IFD} generated by a second inverter (e.g., an IFD) in an ideal electronic dimming ballast.

FIG. 4B is a diagram illustrating an example of the magnetic flux of a primary winding of a transformer driven by the IFD inverter voltage V_{IFD} shown in FIG. 4A.

FIG. 5A is graph illustrating an example of the IFD inverter voltage V_{IFD} generated by a second inverter circuit under non-ideal conditions.

FIG. 5B is a diagram illustrating an example of the magnetic flux of a primary winding of a transformer driven by the IFD inverter voltage V_{IFD} shown in FIG. 5A.

FIG. 6A is a diagram illustrating an example of a primary winding of a transformer with an air core.

FIG. 6B is a diagram illustrating an example of a primary winding of a transformer with a ferrite core.

FIG. 7A is a diagram illustrating an example waveform of a primary current I_{PRI} through a primary winding of a transformer.

FIG. 7B is a diagram illustrating an example waveform of a primary current I_{PRI} when a core of a transformer is saturated.

FIG. 8 is a diagram illustrating an example of an adjusted duty cycle of a second inverter circuit at startup.

FIG. 9A is a diagram illustrating an example waveform of a first drive voltage for controlling a first switch of a second inverter circuit.

FIG. 9B is a diagram illustrating an example waveform of a second drive voltage for controlling a second switch of a second inverter circuit.

FIG. 10A is a diagram illustrating an example envelope of a primary current I_{PRI} conducted through a primary winding of a transformer without an adjusted duty-cycle.

FIG. 10B is a diagram illustrating an example envelope of a primary current I_{PRI} conducted through a primary winding of a transformer while a microprocessor is utilizing the adjusted duty-cycle.

FIG. 11 is a diagram illustrating an example of an adjusted duty cycle of a second inverter circuit when dimming from high end.

FIG. 12 is a flow chart illustrating an example of an IFD duty-cycle adjustment procedure executed by a microprocessor of a control circuit to adjust a present duty cycle of a second inverter circuit.

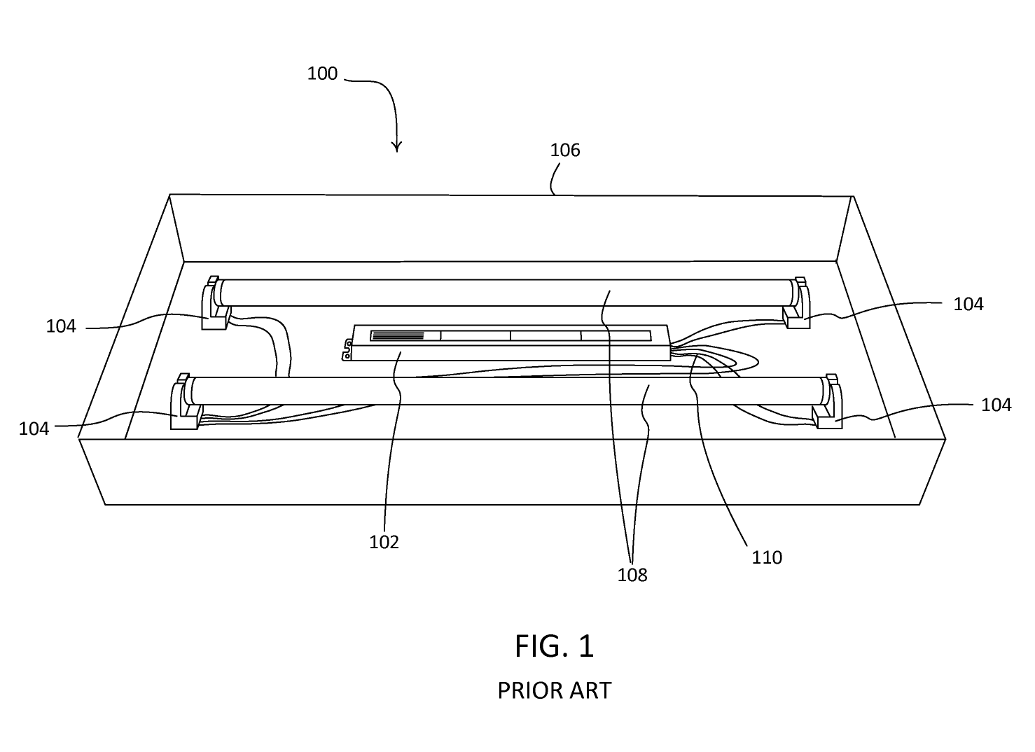

### DETAILED DESCRIPTION

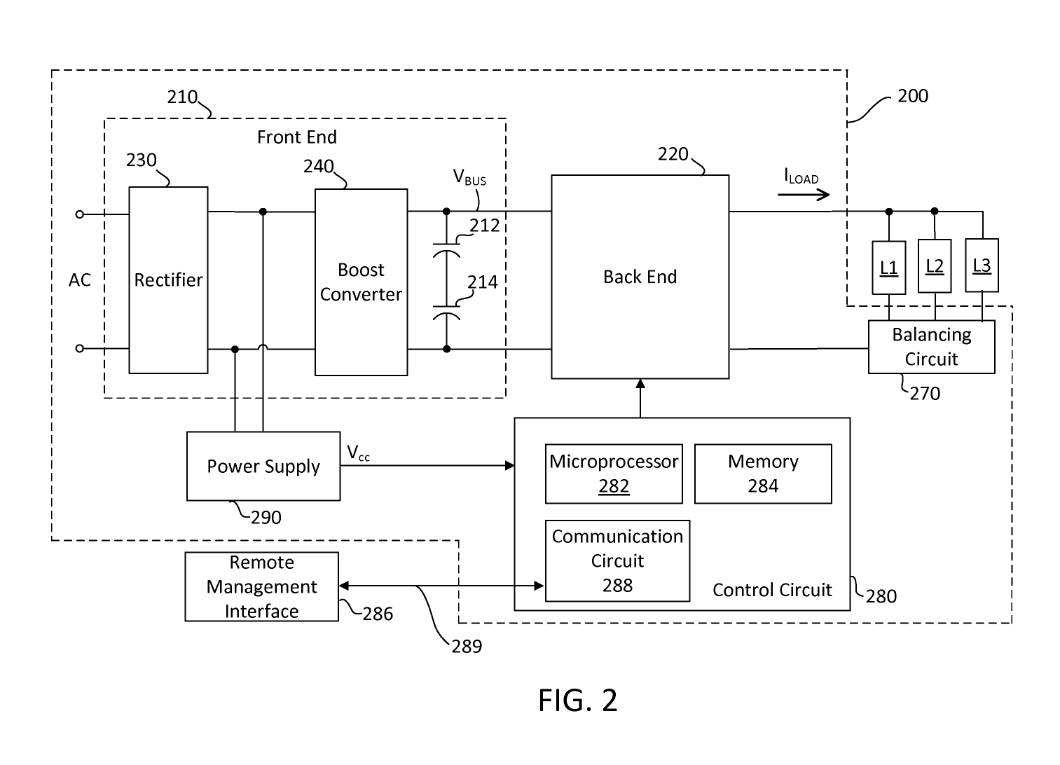

An example of an electronic dimming ballast 200 for driving three fluorescent lamps L1, L2, L3 in parallel is shown in FIG. 2. The electronic dimming ballast 200 may drive any number of lamps. Electronic ballasts typically can be analyzed as comprising a front end circuit 210 and a back end circuit 220. The front end circuit 210 typically includes a rectifier 230 for generating a rectified voltage from an alternating-current (AC) line voltage, and a power converter, for example, a boost converter 240, for generating a direct-current (DC) bus voltage V_{BUS} across a capacitive energy storage circuit (e.g., two series-connected bus capacitors 212, 214 as shown in FIG. 2). The boost converter 240 may be coupled to the rectifier 230 and may boost the magnitude of the rectified voltage above the peak of the line voltage to produce the DC bus voltage V_{BUS}. The boost converter 260 may improve the total harmonic distortion (THD) and the power factor of the input current to the ballast 200. The front end circuit 210 may provide the DC bus voltage V_{BUS} to the back end circuit 220.

The back end circuit 220 may include one or more inverters for converting the DC bus voltage V_{BUS} to one or more corresponding high-frequency AC voltages, and an output circuit comprising a resonant tank circuit for coupling the high-frequency AC voltage to the lamp electrodes. A balancing circuit 270 may be provided in series with the three lamps L1, L2, L3 to balance the currents through the lamps and to prevent any lamp from shining brighter or dimmer than the other lamps.

A control circuit 280 may generate drive signals to control the operation of the back end circuit 220 so as to provide a desired load current L_{LOAD} to the lamps L1, L2, L3. A power supply 290 may be connected across the outputs of the rectifier 230 to provide a DC supply voltage V_{cc} for powering the control circuit 280. The control circuit 280 may include one or more processors (e.g., microprocessors), microcontrollers, integrated circuits (e.g., field programmable gate arrays), or the like, in any combination. For example, the illustrated control circuit 280 may include a microprocessor 282 that may execute computer-executable instructions in order to control one or more functional aspects of the ballast electronic dimming ballast 200.

The control circuit 280 may include a memory 284. The memory 284 may be communicatively coupled to the microprocessor 282 and may operate to store information such as computer-executable instructions, configuration settings associated with operation of the electronic dimming ballast 200 (e.g., one or more filament voltage values, a filament voltage lookup table), or the like. The memory 284 may include any component suitable for storing the information. For example, the memory 284 may include one or more components of volatile and/or non-volatile memory, in any combination. The memory 284 may be internal or external with respect to the microprocessor 282. For example, the memory 284 and the microprocessor 282 may be integrated within a microchip. Moreover, the memory 284 may be internal or external with respect to the control circuit 280. During operation of the electronic dimming ballast 200, the microprocessor 282 may store and/or retrieve information, for instance a filament voltage value, from the memory 284. It should be appreciated that functionality of the control circuit 280 may include any combination of one or more of hardware, firmware, or software.

The electronic dimming ballast 200 may be configured to communicate with a user interface, such as a remote management interface 286 that is communicatively coupled to the control circuit 280. The remote management interface 286 may include any component suitable for presenting information to and/or receiving information from a user of the electronic dimming ballast 200. For example, the remote management interface 286 may be a user interface rendered on a device in electrical communication with the electronic dimming ballast 200 (e.g., a computer, a tablet, a smartphone, etc.), may be a discrete device (e.g., a device that includes one or more manually operated input devices such as buttons, switches, etc.), or the like.

The electronic dimming ballast 200 may receive commands, configuration information, or the like, indicated by a user via the remote management interface 286, for example a command to reconfigure a filament voltage. The electronic dimming ballast 200 may provide information for presentation via the user interface, such as a filament voltage currently employed by the electronic dimming ballast 200, respective confirmations of one or more commands received from the user and executed by the microprocessor 282, or the like. For example, the electronic dimming ballast 200 may receive input entered by a user via the remote management interface 286, such as an indication of a desired reconfigured filament voltage, and may confirm receipt and/or implementation of the desired filament voltage via the remote management interface 286, for instance by rendering an indication on a display.

The electronic dimming ballast 200 may include a communication circuit 288 that is communicatively coupled to the control circuit 280, for example via a communication link 289. The communication link 289 may be any suitable communication link, such as a wired communication link (e.g., a digital addressable lighting interface (DALI) link, a network communication link, such as an Ethernet link, a power line communication link, etc.) or a wireless communication link (e.g., a RF communication link, an IR communication link, etc.).

The communication circuit 288 may include one or more components operable for the transmission and/or reception of information comprising signals and/or data. For instance, the communication circuit 288 may include a transceiver, a modem, and/or the like. One or more components of the control circuit 280, for instance the microprocessor 282, may be configured to receive commands and/or configuration information pertaining to operation of the electronic dimming ballast 200 via the communication circuit 288. For example, the microprocessor 282 may receive information, such as operational commands, via the communication circuit 288 from one or more external components, such as the remote management interface 286. One or more components of the control circuit 280, for example the microprocessor 282, may be configured to transmit information via the communication circuit 288. For example, the microprocessor 282 may be configured to communicate a current filament voltage applied by the electronic dimming ballast 200, for example to the remote management interface 286 for rendering on a display.

The communication circuit 288 may be configured with respective capabilities to transmit and/or receive information in accordance with one or more communication schemes, as desired. For example, the communication circuit 288 may be configured to be capable of transmitting and receiving information via radio frequency (RF) communication, low voltage communication such as low-voltage differential signaling (LVDS), and/or power line communication (PLC) schemes.

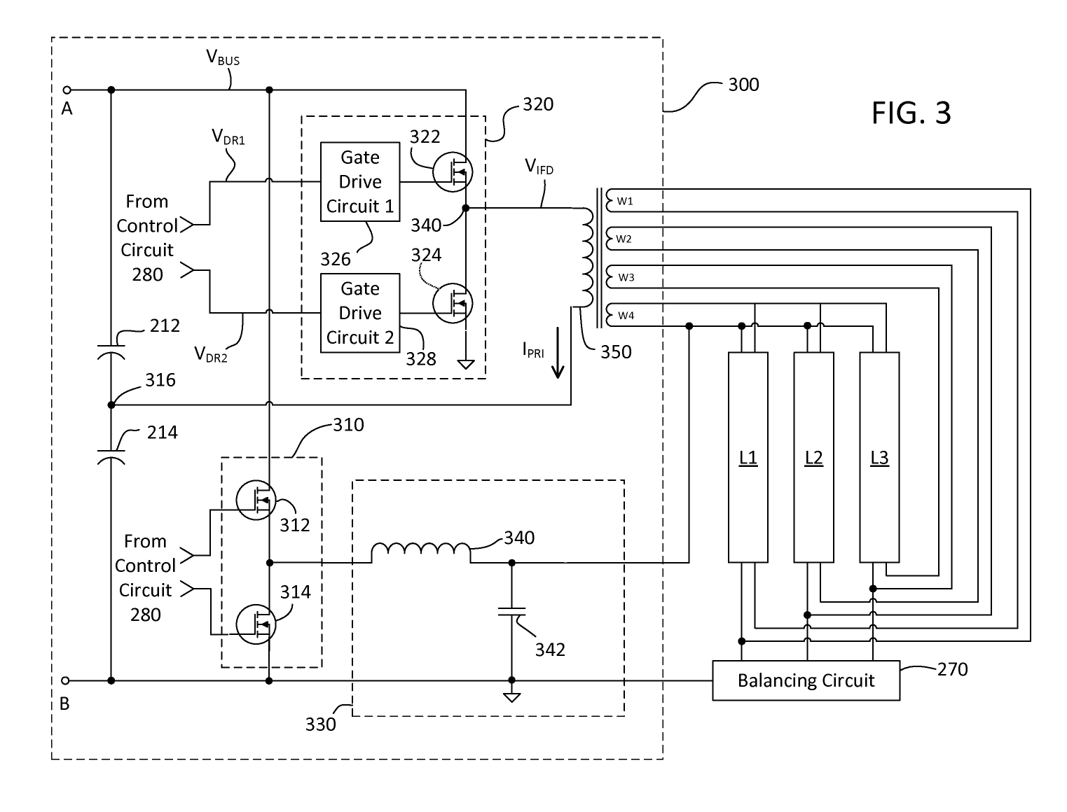

FIG. 3 shows a simplified schematic diagram of an example back end circuit 300 that may be, for example, the back end circuit 220 of the electronic dimming ballast 200 for driving the lamps L1, L2, L3. The back end terminals A, B may be connected to the output of the boost converter 240 for receiving the DC bus voltage V_{BUS}, which, for example, may be generated across two series-connected bus capacitors (e.g., the bus capacitors 212, 214 of the ballast 200 shown in FIG. 2). The back end circuit 300 may include a first inverter circuit 310 and an output circuit 330. The first inverter circuit 310 may generate a high-frequency AC voltage for driving the lamps L1, L2, L3 and may include series-connected first and second switching devices for example, two field-effect transistors (FETs) 312, 314. The output circuit 330 may comprise a resonant tank having a resonant inductor 340 and a resonant capacitor 342. The first inverter circuit 310 may drive the lamps L1, L2, L3 via the resonant inductor 340 and the resonant capacitor 342. The output circuit 330 may filter the output of the first inverter circuit 310 to supply a substantially sinusoidal voltage to the parallel-connected lamps L1, L2, L3.

A control circuit, for example the control circuit 280 depicted in FIG. 2, may drive the FETs 312, 314 of the first inverter 310 using a symmetric (e.g., substantially symmetric) duty cycle switching mode of operation, for example a D(1-D) switching technique. This may mean that one, and only one, of the FETs 312, 314 may be conducting at a given time, and at least one of the FETs 312, 314 may be conductive at all times. For example, when the FET 312 is conducting, then the output of the first inverter 310 may be pulled upwardly toward the DC bus voltage. When the FET 314 is conducting, then the output of the first inverter 310 may be pulled downwardly toward circuit common.

The back end circuit 300 may further comprise a second inverter circuit 320 (e.g., an independent filament drive inverter circuit) that may operate to provide an AC independent filament drive (IFD) inverter voltage V_{IFD} to the filaments of the lamps L1, L2, L3 via a transformer 350. Specifically, the second inverter circuit 320 may drive the primary winding of the transformer 350 with the IFD inverter voltage V_{IFD}, which may cause a primary current I_{PRI} to flow through the primary winding. Filament windings W1, W2, W3, W4 (e.g., the secondary windings of the transformer 350) may be coupled to the filaments of the lamps L1, L2, L3 (e.g., winding W1 may be coupled to a filament of lamp L1; winding W2 may be coupled to a filament of lamp L2; and winding W3 may be coupled to a filament of lamp L3). The winding W4 may be referred to as a common filament winding because it may be coupled to the filaments of the lamps L1, L2, L3. The filaments connected to the common filament winding W4 may be wired in parallel or in series. For example, the common filament winding W4 may be electrically connected to the filaments such that the filaments may be in series with one another or in parallel with one another. FIG. 3 illustrates an example of the common filament winding electrically connected to the filaments such that the filaments are in parallel to one another.

The second inverter circuit 320 may enable independent control of the AC voltages provided to the filaments of the lamps L1, L2, L3. For example, the second inverter circuit 320 may be controlled by the control circuit 280, which may control the first inverter circuit 310. The second inverter circuit 320 may be controlled by a control circuit (not shown) that may be different from the control circuit 280 that controls the first inverter circuit 310. The frequency and/or duty cycle of the second inverter circuit 320 may be driven independently of the frequency and/or duty cycle of the first inverter circuit 310—that is, the control circuit 280 may be capable of setting a different frequency and/or duty cycle for the first inverter circuit 310 than that of the second inverter 320. Still being independent, the duty cycle and/or frequency of the inverters may be controlled to be roughly correlated—for example, such as operating at one-half of the frequency of the first inverter circuit 310.

The filament windings W1, W2, W3, W4 may provide AC voltages to the filaments of the lamps L1, L2, L3 to keep the filaments warm through the entire dimming range. The filaments may be heated when the control circuit 280 is dimming the lamps L1, L2, L3 to low end and during preheating of the filaments before striking the lamps. The control circuit 280, for example the microprocessor 282, may retrieve a value corresponding to the desired magnitude of the AC filament voltages from the memory 284 and may cause the second inverter 320, for example the first and second switching devices 322, 324, to apply the IFD inverter voltage V_{IFD} to the primary winding of the transformer 350, such that the secondary windings provide the AC filament voltages to the respective filaments of the lamps L1, L2, L3.

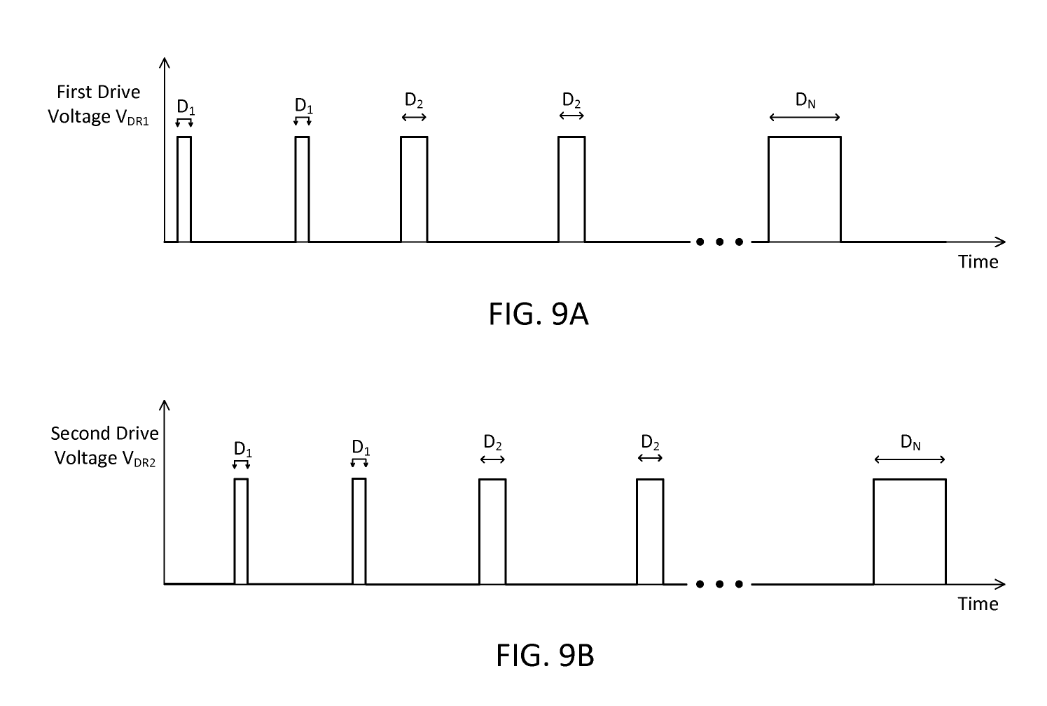

The second inverter circuit 320 may include series-connected first and second semiconductor switching devices 322, 324, for example, two field-effect transistors (FETs). The semiconductor switching devices may be referred to herein as switches. The semiconductor switching devices 322, 324 may be rendered conductive and non-conductive in response to drive voltages V_{DR1}, V_{DR2} received from the control circuit 280. The drive voltages V_{DR1}, V_{DR2} may be coupled to the gates of the semiconductor switch devices 322, 324, for example, via respective gate drive circuits 326, 328. The primary winding of the transformer 350 may be coupled between an inverter center 340 (i.e., the junction of the semiconductor switching devices 322, 324 of the second inverter circuit 320) and a bus capacitor junction 316 (e.g., the junction of the bus capacitors 212, 214). The semiconductor switch devices 322, 324 of the second inverter circuit 320 may be driven using a symmetric duty cycle switching mode of operation. This may mean that the semiconductor switching devices 322, 324 may be rendered conductive and non-conductive at the same duty cycle, but may be driven to be conductive at different times (e.g., offset from each other, for example, as shown in FIGS. 9A and 9B). When the first semiconductor switching device 322 is conducting, the inverter center 340 (e.g., the IFD inverter voltage V_{IFD}) may be pulled up towards the DC bus voltage V_{BUS}. When the second semiconductor switching device 324 is conducting, the output of the second inverter circuit 320 (e.g., the inverter center 340) may be pulled down towards circuit common.

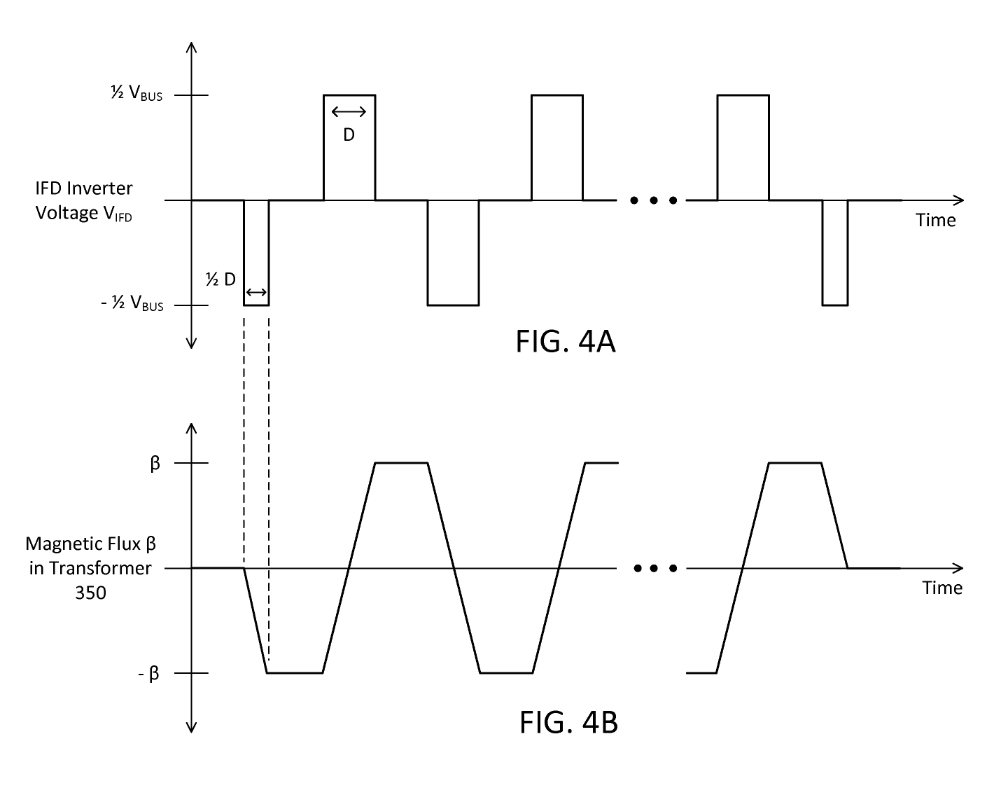

FIG. 4A is graph illustrating an example of an IFD inverter voltage V_{IFD} generated by an IFD circuit (e.g., the second inverter 320 shown in FIG. 3) in an ideal electronic dimming ballast. If bus capacitors (e.g., the bus capacitors 212, 214) are balanced (e.g., the bus capacitors have the same capacitance), then the electronic dimming ballast may be said to be ideal. In the first half duty cycle (½ D), the second semiconductor switching device 324 may be conducting, and the output of the second inverter circuit 320 may be pulled toward circuit common. The next duty cycle may be a full duty cycle (D), where the first semiconductor switching device 322 may be conducting, and the output of the second inverter circuit 320 may be pulled toward the DC bus voltage V_{BUS}. This symmetric duty cycle switching mode of the semiconductor switching devices 322, 324 may continue (e.g., until the ballast 200 is turned off), and may end with a half duty cycle (½ D) of the second semiconductor switching device 424.

FIG. 4B is a diagram illustrating an example of the magnetic flux β (e.g., which may have units of volt-seconds) of the primary winding of the transformer 350 driven by the IFD inverter voltage V_{IFD} shown in FIG. 4A. If the bus capacitors 212, 214 are balanced and the duty cycle of the semiconductor switching devices 322, 324 is maintained evenly between the semiconductor switching devices 322, 324, then an equal amount of positive volt-seconds and negative volt-seconds may be applied to the primary winding of the transformer 350. This may allow the transformer 350 to operate without saturating.

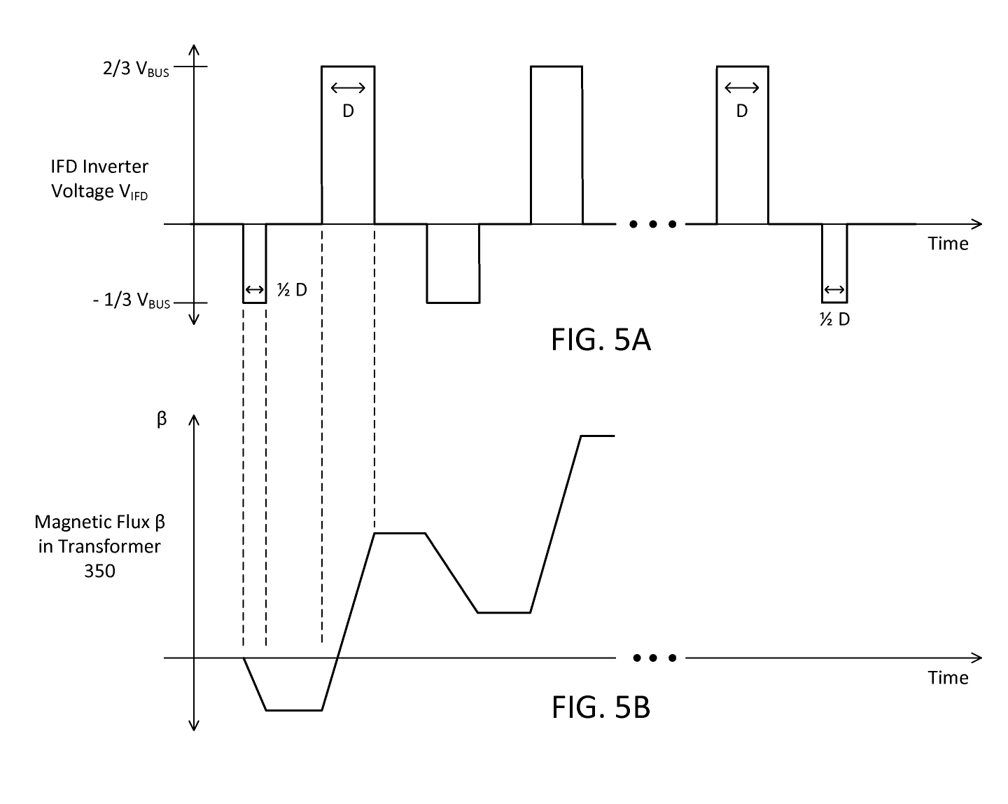

FIG. 5A is graph illustrating an example of an IFD inverter voltage V_{IFD} generated by an IFD circuit (e.g., the second inverter circuit 320) under non-ideal conditions. If the bus capacitors 212, 214 are unbalanced (e.g., the bus capacitors have different capacitances and/or leakage resistances), the second inverter circuit 320 may be said to be operating under non-ideal conditions. Even if the bus capacitors 212, 214 are rated the same, they may have unequal capacitances and/or leakage resistances if the capacitors have different tolerances, have different ages, have experienced storage or operating conditions, etc. For example, as shown in FIG. 5A, one capacitor may charge to a voltage having a magnitude equal to two-thirds of the magnitude of the bus voltage V_{BUS}, while the other capacitor charge to a voltage having a magnitude equal to one-third the magnitude of the bus voltage V_{BUS}. Similar to FIG. 4A, in the first half duty cycle (½D), the second semiconductor switching device 324 may be conducting, and the output of the second inverter circuit 320 (e.g., the inverter center 340) may be pulled toward circuit common. The next duty cycle may be a full duty cycle (D), where the first semiconductor switching device 322 may be conducting, and the output of the second inverter circuit 320 may be pulled toward the DC bus voltage V_{BUS}. This symmetric duty cycle switching mode of the semiconductor switching devices 322, 324 may continue (e.g., until the ballast is turned off), and may end with a half duty cycle (½ D), the second semiconductor switching device 324.

FIG. 5B is a diagram illustrating an example of the magnetic flux β (e.g., which may have units of volt-seconds per meter squared) of a core the transformer 350 driven by the IFD inverter voltage V_{IFD} shown in FIG. 5A. Even though the duty cycle of the semiconductor switching devices 322, 324 is maintained evenly between the semiconductor switching devices 322, 324, the magnitude of the IFD inverter voltage V_{IFD} differs in the positive and negative cycles since the bus capacitors 212, 214 are un-balanced. Therefore, an un-equal amount of positive volt-seconds as compared to negative volt-seconds may be applied to the core of the transformer 350. As a result, the magnetic flux in the core of the transformer 350 may begin to increase in one direction, thereby causing the core of the transformer to saturate.

This may cause the magnetic flux in the transformer 350 to “walk” in a certain direction, for example, depending on which bus capacitor 212, 214 has more voltage on it. After a certain point, the additional magnetic flux may cause the core of the transformer 350 to saturate, which may cause the core to act like an air core. For example, the inductance of the core of the transformer 350 may drop by a factor of 2,000 to 3,000 times, for example, depending on the permeability of the core of the transformer. The saturation of the core of the transformer 350 may cause the magnitude of the primary current I_{PRI} to become very large. The high magnitude of the primary current I_{PRI} may ultimately reverse the saturation of the core of the transformer 350, for example, because over time the primary current may charge and discharge the bus capacitors 212, 214 causing the bus capacitors to reach a balance point and reset to the same voltage. However, while the magnitude of the primary current I_{PRI} is high and the bus capacitors 212,214 are balancing, the semiconductor switching devices 322, 324 of the second inverter circuit 320 may be overwhelmed and/or degraded since, for example, the magnitude of the current may exceed the safe operating area of the semiconductor switching devices.

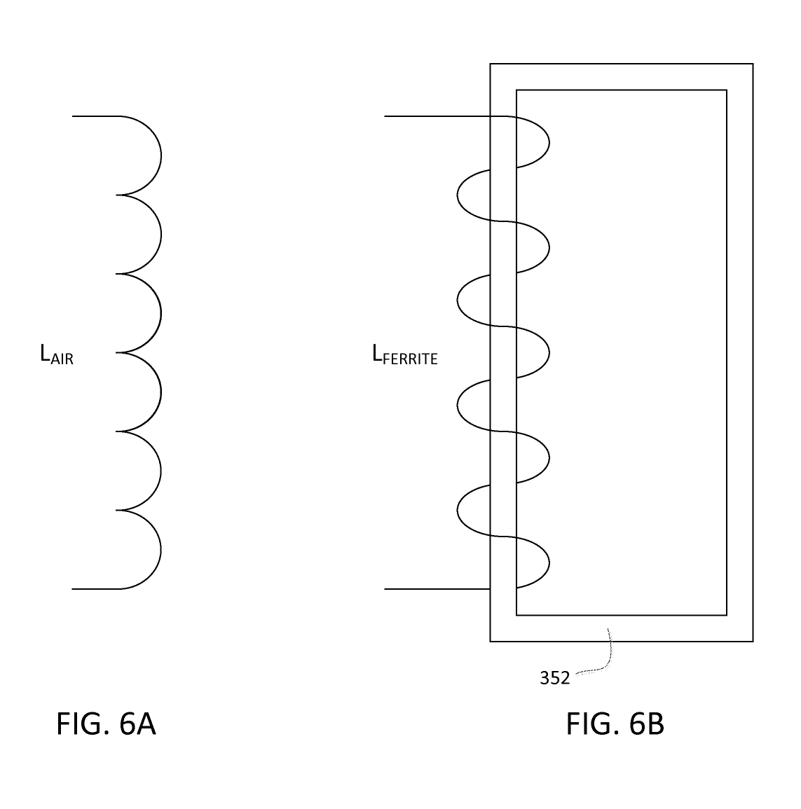

As noted herein, the second inverter circuit 320 may operate to provide the IFD inverter voltage V_{IFD} to the primary winding of the transformer 350. FIG. 6A is a diagram illustrating an example of a primary winding of a transformer with an air core. FIG. 6B is a diagram illustrating an example of a primary winding of a transformer with a core 352 (e.g., ferrite core). The core 352 of the transformer of FIG. 6B may act as an amplifier of the flux that may flows through the primary winding. The more flux, then the more coupling, which may increase the inductance of the transformer. However, if a transformer having a ferrite core becomes saturated (e.g., as shown in FIGS. 5A and 5B), then the transformer may act as if it has an air core, thereby reducing its inductance. This reduction in inductance may cause other unfavorable consequences in the transformer (e.g., resistance to current flow may reduce).

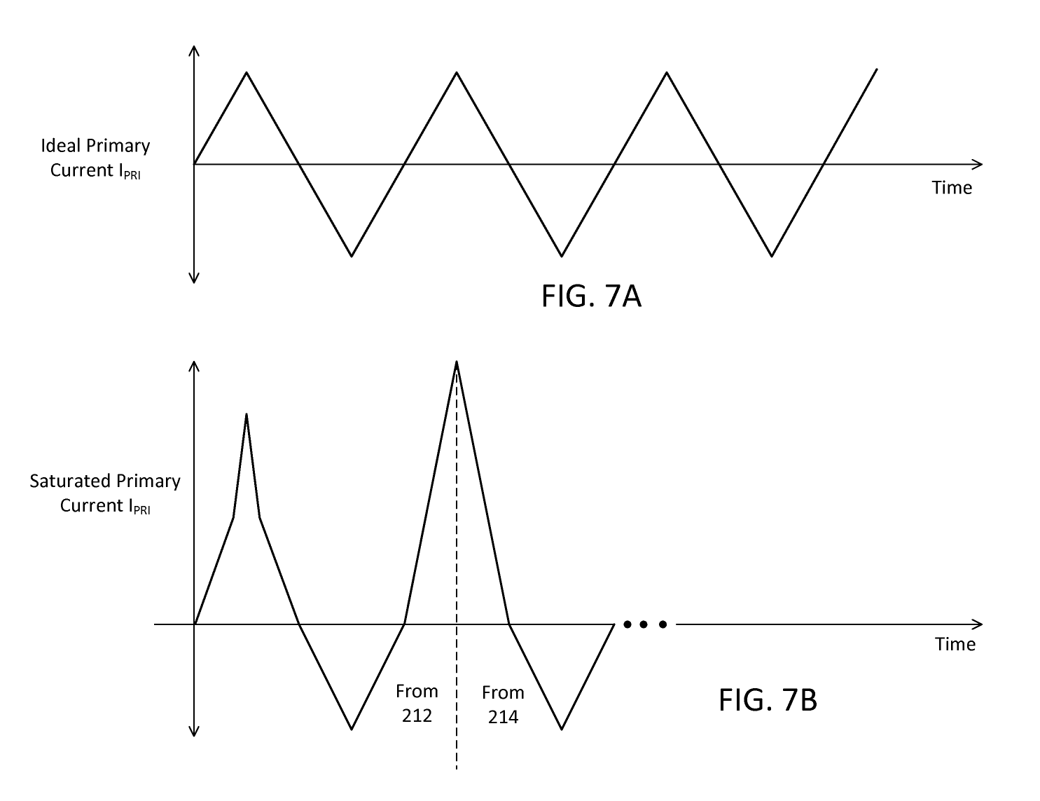

As noted herein, the magnitude of the primary current I_{PRI} through the primary winding of the transformer 350 may change if the core (e.g., core 352) becomes saturated. FIG. 7A is a diagram illustrating an example waveform of a current conducted through the primary winding of a transformer (e.g., the primary current I_{PRI} conducted through the primary winding of the transformer 350). As shown in FIG. 7A, the waveform of the primary current I_{PRI} may be substantially uniform (e.g., an even triangular form), for example, when the core of the transformer 350 is not saturated. The uniform waveform of the primary current I_{PRI} may be due to an equal amount of volt-seconds being applied to the primary winding of the transformer 350 in each direction. FIG. 7B is a diagram illustrating an example waveform of the primary current I_{PRI} when the core of the transformer 350 is saturated. As shown in FIG. 7B, the waveform of the primary current I_{PRI} when the core is saturated may be disproportional in one direction. For example, if the core of the transformer 350 becomes saturated, the magnitude of the primary current I_{PRI} may increase over time. Further, the rate of change of the primary current I_{PRI} may increase over time. The core of the transformer 350 may saturate in one direction (e.g., as shown in FIG. 7B) or in both directions. As shown, the magnitude of the primary current I_{PRI} at a given time during saturation may be greater than the magnitude of the primary current when the core is unsaturated. This increased magnitude of the primary current I_{PRI} may cause the issues described herein (e.g., degradation of the semiconductor switching devices 322, 324 due to operation outside their safe operating area).

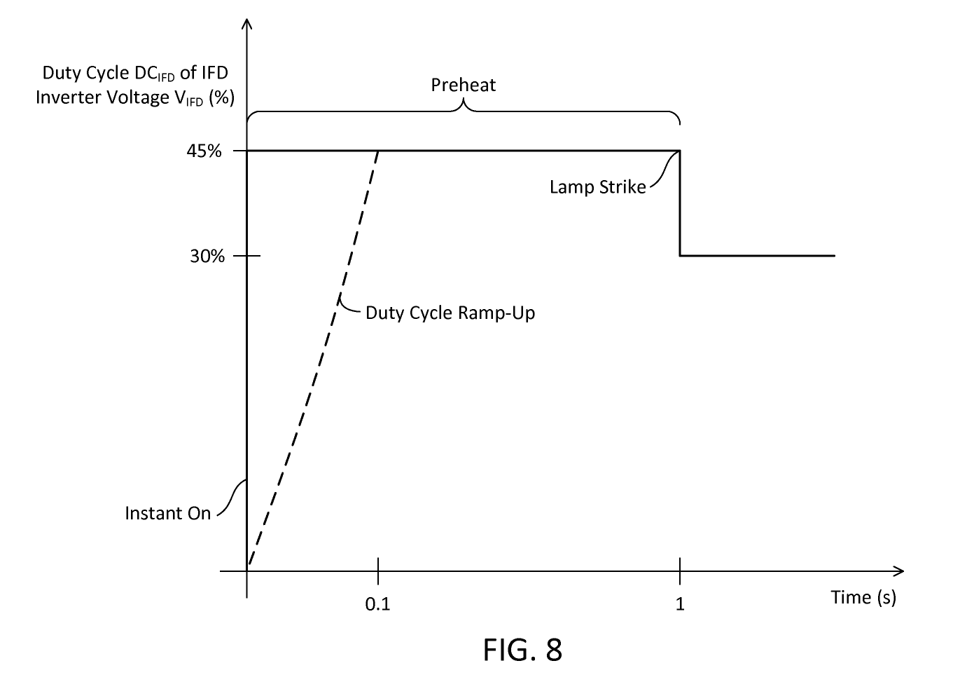

If the duty cycle of the IFD inverter voltage V_{IFD} is adjusted, then saturation of the core of the transformer 350 may not occur. FIG. 8 is a diagram illustrating an example of an adjusted duty cycle of an IFD inverter voltage V_{IFD} generated by an IFD circuit (e.g., the second inverter circuit 320) at startup. As noted herein, the second inverter circuit 320 may generate the IFD inverter voltage V_{IFD} to heat the filaments of the lamps L1, L2, L3, for example, at startup (e.g., at preheat before striking the lamps). At startup, the control circuit 280 may maintain the duty cycle of the IFD inverter voltage V_{IFD} at a target duty cycle (e.g., approximately 45%) for the duration of a specified period of time (e.g., approximately 1 second), after which the lamps L1, L2, L3 may be struck. After the lamps L1, L2, L3 are struck, the control circuit 280 may decrease the duty cycle of the IFD inverter voltage V_{IFD} (e.g., to approximately 30%). The target duty cycle may be set such that the filaments of the lamps L1, L2, L3 are sufficiently preheated when the lamps L1, L2, L3 are ready to be struck. The specified time may be selected to be long enough to allow for the filaments of the lamps L1, L2, L3 to preheat and/or not too long to alter a user's expected experience (e.g., turn-on time). FIG. 8 illustrates an example of an “instant on” duty cycle. The “instant on” duty cycle may be utilized by the semiconductor switching devices 322, 324 of the second inverter circuit 320. When the “instant on” duty cycle is utilized, the semiconductor switching devices 322, 324 may go immediately to a 45% duty cycle, which in turn may cause saturation of the core of the transformer 350 and degradation of the semiconductor switching devices 322, 324.

FIG. 8 also illustrates an example of an adjusted (e.g., ramp-up) duty cycle. The control circuit 280 may control the semiconductor switching devices 322, 324 of the second inverter circuit 320 using the adjusted duty cycle of FIG. 8. The IFD inverter voltage V_{IFD} may be adjusted from a current duty cycle (e.g., starting duty) to a target duty cycle, for example, at a rate. The rate may be calculated as duty cycle percent change per unit time. The rate may be calculated as duty cycle percent change per inverter cycle (e.g., or per two or more inverter cycles). For example, FIG. 8 illustrates an example adjusted duty cycle that increases from a duty cycle of 0% to a duty cycle of 45% over 100 ms. At the end of the specified period of time (e.g., 1 second), the control circuit 280 may control the first inverter circuit 310 to strike the lamps L1, L2, L3. The adjusted duty cycle of FIG. 8 may be utilized so that the core of the transformer 350 may not saturate and/or the semiconductor switching devices 322, 324 may stay within their safe operating area. This may be accomplished by minimizing the volt-seconds that get applied to the core of the transformer 350.

FIGS. 9A and 9B show example waveforms of drive voltages for controlling semiconductor switching devices of an IFD circuit. For example, FIG. 9A may illustrate an example waveform of the first drive voltage V_{DR1} for controlling the first semiconductor switching device 422 of the second inverter circuit 320, and FIG. 9B may illustrate an example waveform of the second drive voltage V_{DR2} for controlling the second semiconductor switching device 424 of the second inverter circuit 320. The duty cycles of the first and second drive voltages V_{DR1}, V_{DR2} may be adjusted (e.g., increased) from D₁ to D_{N}, for example until the target duty cycle DC_{TRGT} of the IFD inverter voltage V_{IFD} is reached. The duty cycles of the first and second drive voltages V_{DR1}, V_{DR2} may be adjusted (e.g., increased) from D₁ to D_{N} at a rate. The duty cycles of the first and second drive voltages V_{DR1}, V_{DR2} may be adjusted according to a duty cycle ramp up, for example, the adjusted (e.g., ramp-up) duty-cycle as shown in FIG. 8. When the first and second drive voltages V_{DR1}, V_{DR2} have a duty cycle D_{N}, the IFD inverter voltage V_{IFD} may be at the target duty cycle DC_{TRGT}. The duty cycles of the first and second drive voltages V_{DR1}, V_{DR2} may be increased every two or more inverter cycles, where each semiconductor switching device 322, 324 may conduct for one duty cycle time period during each inverter cycle.

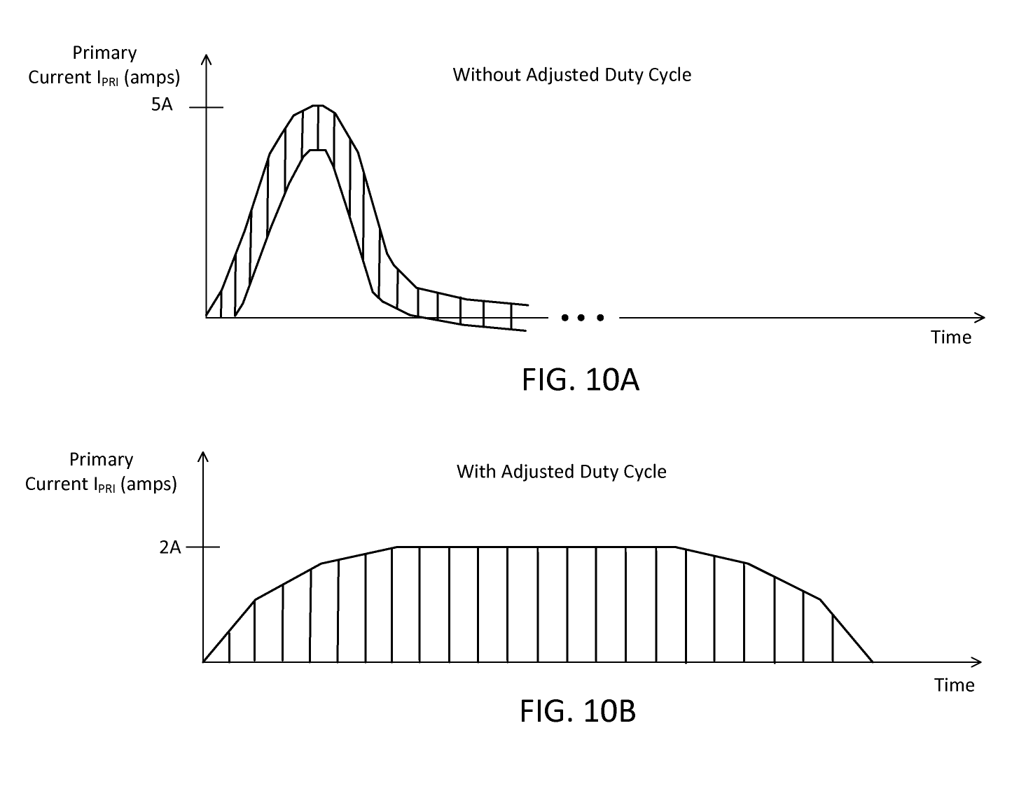

FIG. 10A is a diagram illustrating an example envelope of a primary current conducted through a primary winding of a transformer (e.g., the primary current I_{PRI} conducted through the primary winding of the transformer 350) without an adjusted (e.g., ramp-up) duty-cycle. FIG. 10B is a diagram illustrating an example envelope of the primary current conducted through a primary winding of a transformer (e.g., the primary current I_{PRI} conducted through the primary winding of the transformer 350) while a microprocessor (e.g., microprocessor 282) is utilizing an adjusted (e.g., ramp-up) duty-cycle. If the microprocessor 282 does not utilize the adjusted (e.g., ramp-up) duty-cycle to control the second inverter circuit 320, then the magnitude of the primary current I_{PRI} conducted through the primary winding of the transformer 350 may not return to zero amps after each inverter cycle. If the magnitude of the primary current I_{PRI} does not return to zero amps, then hard switching may occur in the semiconductor switching devices 322, 324. Hard switching may result in one of the semiconductor switching devices 322, 324 trying to turn on while the body diode of the other semiconductor switching device is still conducting current. Hard switching may be very lossy. Hard switching may cause the semiconductor switching device to conduct the current while there is still voltage across the device. The body diode of the semiconductor switching device may not be able to turn off until the magnitude of the current through the device drops to zero amps and/or goes through a negative current, which may reset the junction. The semiconductor switching device may not be able to shed the voltage developed across the device until the magnitude of the current through the device drops to zero amps. Until the magnitude of the current goes to zero amps, the semiconductor switching device may be a lossy device. For example, hard switching may be exemplified by the hump in FIG. 10A when the magnitude of the primary current I_{PRI} does not return to zero amps.

If the microprocessor 282 does not utilize the adjusted (e.g., ramp-up) duty-cycle to control the second inverter circuit 320, then the semiconductor switching devices 322, 324 may see a higher peak current (e.g., 5A). The semiconductor switching devices 322, 324 may be low-resistance semiconductor switching devices (e.g., FETs). The higher peak current may cause the semiconductor switching devices 322, 324 to go into linear mode, where the semiconductor switching devices 322, 324 may stop looking like constant resistance and may increase their resistance. This may make the semiconductor switching devices 322, 324 lossy. For example, the semiconductor switching devices 322, 324 may look like it is clamping the current, which may cause the semiconductor switching devices 322, 324 to absorb the voltage that is available in the circuit, therefore becoming lossy. This may cause the semiconductor switching devices 322, 324 to operate outside of their safe operating area.

If the microprocessor 282 utilizes the adjusted (e.g., ramp-up) duty-cycle to control the second inverter circuit 320, then the aforementioned issues relating to hard switching and peak currents may be avoided. This may improve the performance of the second inverter circuit 320 and/or keep the semiconductor switching devices 322, 324 within their safe operating area. For example, FIG. 10B illustrates an example envelope of the primary current I_{PRI} conducted through the primary winding of the transformer 350 when the second inverter circuit 320 is being controlled according to the adjusted (e.g., ramp-up) duty-cycle. As shown, the magnitude of the primary current I_{PRI} conducted through the primary winding of the transformer 350 may return to zero amps after each inverter cycle, thereby avoiding hard switching. The peak current (e.g., 2A) may also be less than implementations that do not utilize the adjusted duty cycle.

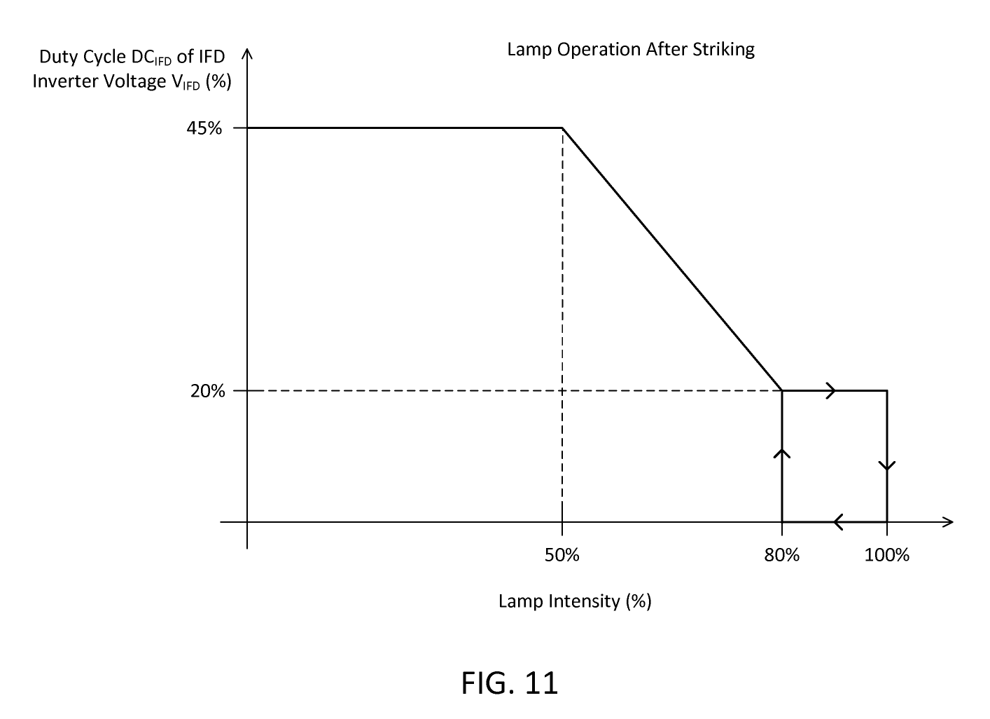

FIG. 11 is a diagram illustrating an example of an adjusted (e.g., ramp-up) duty cycle for controlling an IFD circuit (e.g., the second inverter circuit 320) when dimming from high end. The second inverter circuit 320 may generate the IFD inverter voltage V_{IFD} with a duty cycle of 0% when the intensity of the lamps L1, L2, L3 is near high end intensity (e.g., over 80% intensity). When the duty cycle of the IFD inverter voltage V_{IFD} is at 0%, the filaments may not be heated. The filaments may not need to be heated since the lamps L1, L2, L3 are running at a higher intensity, and in turn at a higher temperature. However, if the lamps L1, L2, L3 are dimmed from the high end intensity, then the adjusted duty cycle may be utilized by the second inverter circuit 320.

FIG. 11 may illustrate an example of the duty cycle of the second inverter circuit 320 versus the intensity of the lamps L1, L2, L3. For example, at 100% lamp intensity, the duty cycle of the second inverter circuit 320 may be 0%. If the intensity of the lamps L1, L2, L3 is changed from 100% to 80% or lower (e.g., as shown in FIG. 11), then the duty cycle of the second inverter circuit 320 may increase. For example, the second inverter circuit 320 may adjust the duty cycle of the IFD inverter voltage V_{IFD} from the present duty cycle DC_{PRES} (e.g., which may be at 0%) to the target duty cycle DC_{TRGT} (e.g., which may be anywhere between 20% to 45% depending on lamp intensity), for example at a rate (e.g., as described herein). Although not exemplified in FIG. 11, an adjusted (e.g., ramp-up) duty cycle similar to the duty cycle shown in FIG. 8 may be utilized by the second inverter circuit 320 when the lamp intensity is decreased from a high end intensity level (e.g., 80%).

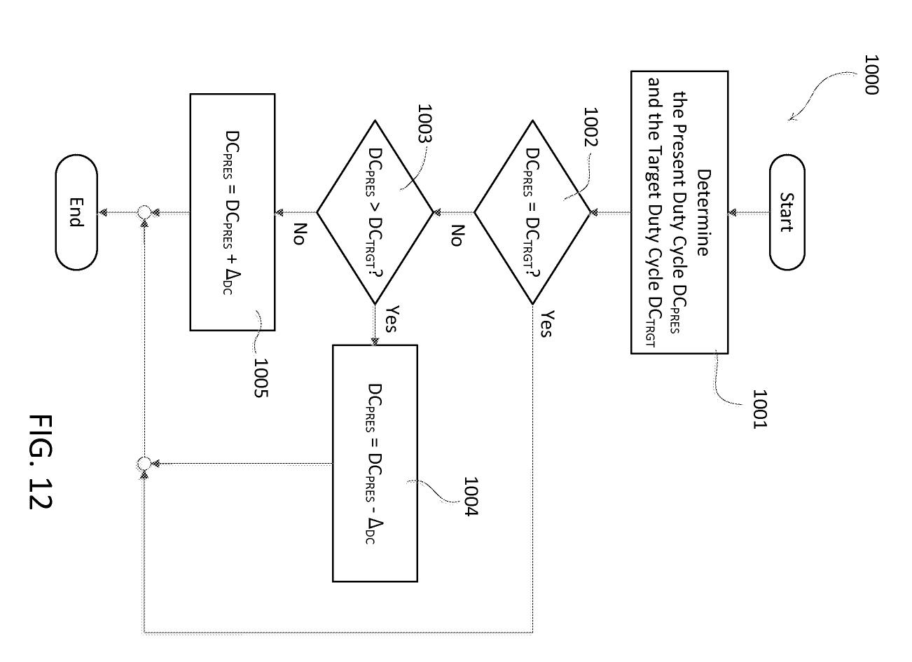

FIG. 12 is a flow chart illustrating an example of an IFD duty-cycle adjustment procedure 1000 executed by a control circuit of a ballast (e.g., the microprocessor 282 of the control circuit 280 of the ballast 200) to adjust a present duty cycle DC_{IFD} of an IFD circuit (e.g., the second inverter circuit 320). The IFD duty-cycle adjustment procedure 1000 may be executed periodically by the microprocessor 282, for example, once every two cycles of the IFD inverter voltage V_{IFD} or predetermined period of time (e.g., approximately every 30-40 microseconds). The IFD duty-cycle adjustment procedure 1000 may be running continuously while the electronic dimming ballast 200 is operating. The IFD duty-cycle adjustment procedure 1000 may be utilized whenever the present duty cycle DC_{IFD} of the second inverter circuit 320 is changed. Particularly, the IFD duty-cycle adjustment procedure 1000 may be utilized when starting up the lamps L1, L2, L3 and when dimming from high end.

The IFD duty-cycle adjustment procedure 1000 may begin at step 1001, where the microprocessor 282 may determine a present duty cycle DC_{IFD} and a target duty cycle DC_{TRGT}. The present duty cycle DC_{IFD} may be 0%, for example, at startup if the second inverter circuit 320 has yet to provide voltage to the primary winding of the transformer 350. The present duty cycle DC_{IFD} may be any percentage between 0% and the target duty cycle DC_{TRGT}. The target duty cycle DC_{TRGT} may be preconfigured, and may be stored within the memory 284 of the control circuit 280. The target duty cycle DC_{TRGT} may change dynamically throughout the operation of the ballast 200. Referring to FIG. 8, at time zero, the present duty cycle DC_{IFD} may be 0% and the target duty cycle may be 45%.

At step 1002, the microprocessor 282 may determine whether or not the present duty cycle DC_{IFD} equals the target duty cycle DC_{TRGT}. If the present duty cycle DC_{IFD} equals the target duty cycle DC_{TRGT}, then the IFD duty-cycle adjustment procedure 1000 may exit. Referring to FIG. 8, the present duty cycle DC_{IFD} may equal the target duty cycle DC_{TRGT} at 100 ms. If the present duty cycle DC_{IFD} does not equal the target duty cycle DC_{TRGT}, then the process may proceed to step 1003. If the present duty cycle DC_{IFD} is greater than the target duty cycle DC_{TRGT} at step 1003, then the control circuit 280 may decrement the present duty cycle DC_{IFD} by a predetermined amount Δ_{DC} (e.g., approximately 0.1%) at step 1004, and the IFD duty-cycle adjustment procedure 1000 may exit. If the present duty cycle DC_{IFD} is not greater than the target duty cycle DC_{TRGT} at step 1003 (e.g., is less than the target duty cycle DC_{TRGT}), then the control circuit 280 may increment the present duty cycle DC_{IFD} by the predetermined amount Δ_{DC} at step 1005, and the IFD duty-cycle adjustment procedure 1000 may exit.

Accordingly, since the control circuit 280 may execute the IFD duty-cycle adjustment procedure 1000 periodically and the control circuit may be limited to adjusting (e.g., only adjusting) the present duty cycle DC_{IFD} by the predetermined amount Δ_{DC}, the present duty cycle DC_{IFD} may ramp from 0% to 45% across 100 msec, for example, as shown in FIG. 8. The rate of increase of the present duty cycle DC_{IFD}, for example as shown in FIG. 8, may be selected to be slow enough that the semiconductor switching devices 322, 324 of the second inverter circuit 320 stay within their safe operating area, but fast enough that the filaments of the lamps L1, L2, L3 are sufficiently preheated (e.g., for striking the lamp). The rate of adjustment of the present duty cycle DC_{PRES} may be controlled to be below a threshold (e.g., an upper threshold). The upper threshold may be determined such that saturation of the core of the transformer 350 is avoided and/or the semiconductor switching devices 322, 324 of the second inverter circuit 320 stay within their safe operating area. For example, the upper threshold may be the “instant on” duty cycle rate exemplified in FIG. 8. The rate may be controlled to be above a threshold (e.g., a lower threshold). The lower threshold may be selected such that the second inverter circuit 320 sufficient heats the filaments of the lamps L1, L2, L3.

The control circuit 280 may maintain the rate below the upper threshold and/or above the lower threshold. The rate may be controlled and/or maintained to be slower than and/or below the upper threshold. The rate may be controlled and/or maintained to be faster than and/or above the lower threshold. The rate of the adjusted duty cycle may be altered over time. The rate may be calculated as duty cycle percent change per unit time. The rate may be calculated as duty cycle percent change per inverter cycle (e.g., or per two or more inverter cycles). For example, the rate may be an increase of 0.01% duty cycle per two inverter cycles. For example, even if the adjusted duty cycle is utilized, the core of the transformer 350 may saturate, but may do so at a lower current, which may keep the magnitude of the primary current I_{PRI} at a level that is within the safe operating area of the semiconductor switching devices 322, 324.

A lamp current control loop may be utilized by the electronic dimming ballast 200. A duty cycle control loop (e.g., the duty cycle process exemplified in FIG. 12) may be utilized in conjunction with the lamp current control loop. For example, the duty cycle control loop may be independent of the lamp current control loop, other than the fact that the target duty cycle for the second inverter circuit 320 may be a function of the lamp current I_{L}. For example, two control loops (e.g., an adjusted duty cycle control loop and a lamp current control loop) may be going at the same time. The lamp current control loop may be tracking a target current. The target current may be adjusted and when the current reaches the target current, the lamp current control loop may stop. Then an adjusted duty cycle control loop may follow.

1. An electronic dimming ballast for driving a gas discharge lamp having a filament, the electronic dimming ballast comprising:
a first inverter for generating a first high-frequency alternating current (AC) voltage for powering the gas discharge lamp; and
a second inverter for generating a second high-frequency AC voltage for heating the filament, wherein the second inverter is driven independent of the first inverter; and
wherein the second inverter is configured to adjust a duty cycle of the second high-frequency AC voltage from a starting duty cycle to a target duty cycle at a rate, the rate controlled to be below a threshold.

2. The electronic dimming ballast of claim 1, further comprising:
a controller for maintaining the rate below the threshold.

3. The electronic dimming ballast of claim 1, wherein the rate is controlled to be above a lower threshold.

4. The electronic dimming ballast of claim 1, wherein upon reaching the target duty cycle, the first inverter is configured to strike the lamp.

5. The electronic dimming ballast of claim 1, wherein the second inverter further comprises a transformer having a primary winding configured to receive the second high-frequency AC voltage and a secondary winding configured to be coupled to the filament of the lamp for heating the filament.

6. The electronic dimming ballast of claim 5, wherein the second inverter is configured to adjust the duty cycle of the second high-frequency AC voltage such that saturation of the transformer of the second inverter is avoided.

7. The electronic dimming ballast of claim 1, wherein the second inverter is configured to be adjusted such that switches of the second inverter stay within a safe operating area.

8. The electronic dimming ballast of claim 1, wherein the rate is calculated as duty cycle percent change per unit time.

9. The electronic dimming ballast of claim 1, wherein the rate is calculated as duty cycle percent change per inverter cycle.

10. The electronic dimming ballast of claim 1, wherein the second inverter is adjusted every two inverter cycles.

11. The electronic dimming ballast of claim 1, wherein the rate is 0.01% duty cycle per two inverter cycles.

12. The electronic dimming ballast of claim 1, wherein the starting duty cycle is 0%, the target duty cycle is 45%, and the second inverter is configured to be adjusted from the starting duty cycle to the target duty cycle in 100 ms.

13. The electronic dimming ballast of claim 1, wherein the second inverter is configured to periodically increase the duty cycle of the second high-frequency AC voltage from the starting duty cycle to the target duty cycle at the rate.

14. The electronic dimming ballast of claim 1, wherein an operating frequency of the first high-frequency AC voltage generated by the first inverter is driven independently of an operating frequency of the second high-frequency AC voltage generated by the second inverter.

15. The electronic dimming ballast of claim 1, wherein the first inverter comprises a half-bridge inverter having two semiconductor switches configured to be driven using a symmetric duty cycle switching mode of operation to generate the first high-frequency AC voltage.

16. The electronic dimming ballast of claim 1, wherein the second inverter comprises a half-bridge inverter having two semiconductor switches configured to be driven using a symmetric duty cycle switching mode of operation to generate the second high-frequency AC voltage.

17. The electronic dimming ballast of claim 1, further comprising:
a control circuit configured to control generation of the first and second high frequency AC filament voltages.

18. A method of driving a gas discharge lamp having a filament, the method comprising:
driving a first inverter to generate a first high-frequency alternating current (AC) voltage for powering the gas discharge lamp; and
driving a second inverter to generate a second high-frequency AC voltage for heating the filament, wherein the second inverter is driven independent of the first inverter;
wherein the second inverter is configured to adjust a duty cycle of the second high-frequency AC voltage from a starting duty cycle to a target duty cycle at a rate, the rate controlled to be below a threshold.

19. The method of claim 18, wherein a controller maintains the rate below the threshold.

20. The method of claim 18, wherein the rate is controlled to be above a lower threshold.

21. The method of claim 18, wherein upon reaching the target duty cycle, the method further comprises preheating and striking the lamp via the first inverter.

22. The method of claim 18, wherein the second inverter further comprises a transformer having a primary winding configured to receive the second high-frequency AC voltage and a secondary winding configured to be coupled to the filament of the lamp for heating the filament.

23. The method of claim 22, wherein the second inverter is configured to adjust the duty cycle of the second high-frequency AC voltage such that saturation of the transformer of the second inverter is avoided.

24. The method of claim 18, wherein the second inverter is configured to be adjusted such that switches of the second inverter stay within a safe operating area.

25. The method of claim 18, wherein the rate is calculated as duty cycle percent change per unit time.

26. The method of claim 18, wherein the rate is calculated as duty cycle percent change per inverter cycle.

27. The method of claim 18, wherein the second inverter is adjusted every two inverter cycles.

28. The method of claim 18, wherein the rate is 0.01% duty cycle per two inverter cycles.

29. The method of claim 18, wherein the starting duty cycle is 0%, the target duty cycle is 45%, and the second inverter is adjusted from the starting duty cycle to the target duty cycle in 100 ms.

30. The method of claim 18, wherein the second inverter is configured to periodically increase the duty cycle of the second high-frequency AC voltage from the starting duty cycle to the target duty cycle at the rate.

31. The method of claim 18, wherein an operating frequency of the first high-frequency AC voltage generated by the first inverter is driven independently of an operating frequency of the second high-frequency AC voltage generated by the second inverter.

32. The method of claim 18, wherein the first inverter comprises a half-bridge inverter having two semiconductor switches configured to be driven using a symmetric duty cycle switching mode of operation to generate the first high-frequency AC voltage.

33. The method of claim 18, wherein the second inverter comprises a half-bridge inverter having two semiconductor switches configured to be driven using a symmetric duty cycle switching mode of operation to generate the second high-frequency AC voltage.

34. The method of claim 18, further comprising:
controlling generation of the first and second high frequency AC filament voltages with a control circuit.

35. A method of driving a gas discharge lamp having a filament, the method comprising:
driving an independent filament drive inverter with a duty cycle to generate a second high-frequency AC voltage, wherein the duty cycle is periodically increased from a starting duty cycle to a target duty cycle;
applying the second high-frequency AC voltage the filament of the gas discharge lamp;
upon the duty cycle reaching the target duty cycle, driving a lamp inverter to generate a first high-frequency AC voltage; and
applying the first high-frequency AC voltage to the lamps.
